(19) United States
(12) Patent Application Publication
(10) Pub. No.: US 2023/0339478 A1
(43) Pub. Date: Oct. 26, 2023

(54) DISTURBANCE ESTIMATION OF ERROR BETWEEN TWO DIFFERENT VEHICLE MOTION MODELS

(71) Applicant: TOYOTA RESEARCH INSTITUTE, INC., LOS ALTOS, CA (US)

(72) Inventor: SARAH M. KOEHLER, Los Altos, CA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 17/726,444

(22) Filed: Apr. 21, 2022

(51) Int. Cl. B60W 40/114; B60W 40/12; B60W 40/105

(52) U.S. Cl. CPC B60W 40/105; B60W 40/114; B60W 40/12; B60W 2520/12; B60W 2520/14; G06K 9/6256

(57) ABSTRACT

Systems and methods are provided for predicting a vehicle’s motion, wherein a first set of predictions of the vehicle’s motion based on a primary model and a second set of predictions of the vehicle’s motion based on a secondary model are made, an error between a prediction in the first set of predictions and the corresponding prediction in the second set of predictions is determined, a disturbance estimation using the error is generated, and one or more other predictions in the first set of predictions based on the primary model are corrected using the disturbance estimation.

### TECHNICAL FIELD

The present disclosure relates generally to predicting motion of a vehicle, and in particular, some implementations may relate to improving vehicle motion prediction by disturbance estimation between two different vehicle motion models.

### DESCRIPTION OF RELATED ART

The modeling of the motion of a vehicle may be accomplished utilizing either a kinematic model or a dynamic model. Kinematic models predict a vehicle’s motion based on a mathematical relationship between various parameters of the movement (e.g., position, velocity, acceleration), without considering the forces that affect the motion. The kinematic model is simpler and has fewer parameters than a dynamic model and assume that no slip occurs between the ground and the tires of the vehicle, which is generally accurate for vehicles moving at low speeds but is inaccurate at higher speeds.

The dynamic model has more parameters and can consider things such as friction between the tires and the ground. Generally, the dynamic model is more accurate a higher speeds. However, at lower speeds (e.g., 5 mph or less), because the dynamic model utilizes velocity in its parameters, as the velocity approaches zero, the predictions can become increasingly inaccurate.

### BRIEF SUMMARY OF THE DISCLOSURE

Various embodiments of the disclosed technology provide an improvement over prior art vehicle motion prediction by utilizing a disturbance estimation generated based on an error between primary and secondary models to correct prediction inaccuracies in the primary model.

According to various embodiments of the disclosed technology, a vehicle motion prediction system is provided. The vehicle motion prediction system can include a memory configured to store a first program based on a primary model and a second program based on a secondary model. The vehicle motion prediction system can further include a processor configured to execute the first program based on the primary model to make a first set of predictions of the vehicle’s motion, execute the second program based on the secondary model to make a second set of predictions of the vehicle’s motion, determine an error between a prediction in the first set of predictions and the corresponding prediction in the second set of predictions, generate a disturbance estimation using the error, and correct one or more other predictions in the first set of predictions based on the primary model using the disturbance estimation.

According to various embodiments of the disclosed technology, a method for predicting a vehicle’s motion is provided. The method can include making a first set of predictions of the vehicle’s motion based on a primary model; making a second set of predictions of the vehicle’s motion based on a secondary model; determining an error between a prediction in the first set of predictions and the corresponding prediction in the second set of predictions; generating a disturbance estimation using the error; and correcting one or more other predictions in the first set of predictions based on the primary model using the disturbance estimation.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 is a functional block diagram illustrating an example system for predicting a vehicle’s motion utilizing a disturbance estimation generated based on an error between primary and secondary models to correct prediction inaccuracies in the primary model in accordance with one embodiment of the systems and methods described herein.

FIG. 3 illustrates an example architecture for predicting a vehicle’s motion based on a dynamic model using derated tire cornering stiffness at lower speeds in accordance with one embodiment of the systems and methods described herein.

FIG. 4 illustrates an example process for predicting a vehicle’s motion based on a dynamic model using derated tire cornering stiffness at lower speeds in accordance with one embodiment of the systems and methods described herein.

FIG. 5 is an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can provide an improved vehicle motion prediction based on a dynamic model using derated tire cornering stiffness.

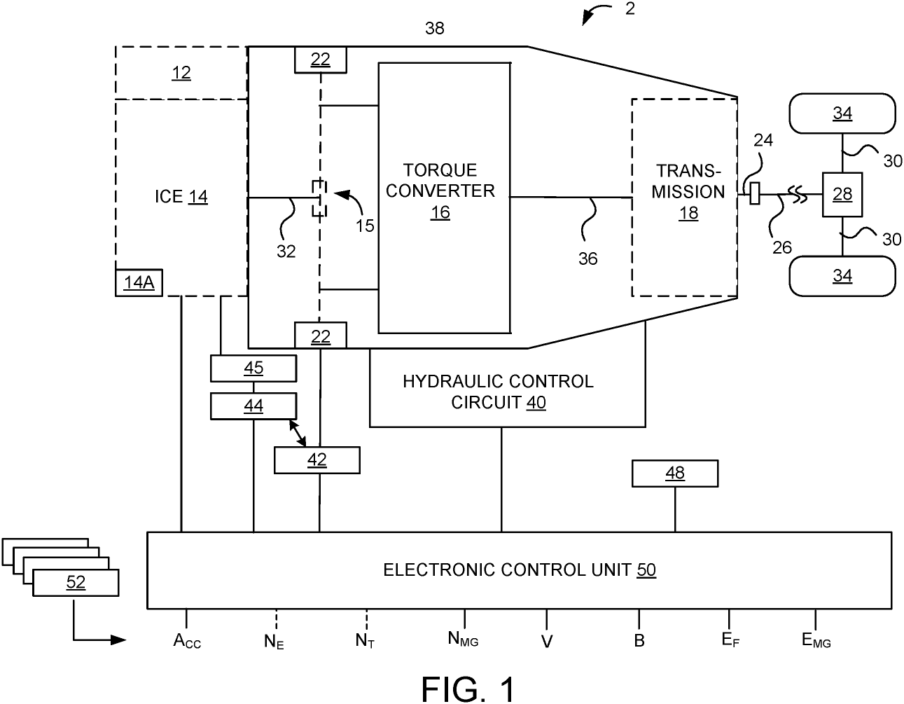

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for an improved vehicle motion prediction by a dynamic model can be implemented in other types of vehicle including gasoline- or diesel-powered vehicles, fuel-cell vehicles, electric vehicles, or other vehicles.

FIG. 1 illustrates a drive system of a vehicle 102 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 102 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14 + MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The examples of FIG. 1 are provided for illustration purposes only as examples of vehicle systems with which embodiments of the disclosed technology may be implemented. One of ordinary skill in the art reading this description will understand how the disclosed embodiments can be implemented with vehicle platforms.

Various embodiments of the present disclosure provide a system and method that uses an error regarding a prediction calculated between a primary model and a secondary model to generate a disturbance estimation that can be used to correct inaccuracies in other predictions made by the primary model.

The system and method of the present disclosure utilizes a vehicle motion prediction program based on a primary model to predict a vehicle’s motion. The primary model can be any type of model utilized to predict vehicle motion. In some embodiments, the primary model can be either a dynamic model or a kinematic model. In some embodiments, the dynamic model is utilized as the primary model. A vehicle motion prediction program based on a secondary model, which is different from the primary model, runs simultaneously in the background. The secondary model is a different type of model that predicts a vehicle’s motion from that of the first model. For example, if the primary model is a dynamic model, the secondary model is a different type of model, such as the kinematic model. However, the reverse could also be true, wherein the kinematic model is the primary model and the dynamic model is the secondary model.

Regardless, an error is determined (e.g., calculated) between predictions made by the primary model and the secondary model. The error may include errors of multiple predictions of the models, for example, errors regarding the heading, yaw rate, lateral velocity, etc. Using this calculated error, a disturbance estimation is generated. The disturbance estimation is then combined with the primary model to correct other predictions.

For example, assume there is an error between the primary model and the secondary model regarding heading prediction. The disturbance estimation may use that error in the heading prediction to provide corrective estimates for predictions regarding yaw rate, lateral velocity, etc. Even though yaw rate and lateral velocity are different measurements from heading, the disturbance estimation may be use errors in heading to correct issues with yaw rate and lateral velocity.

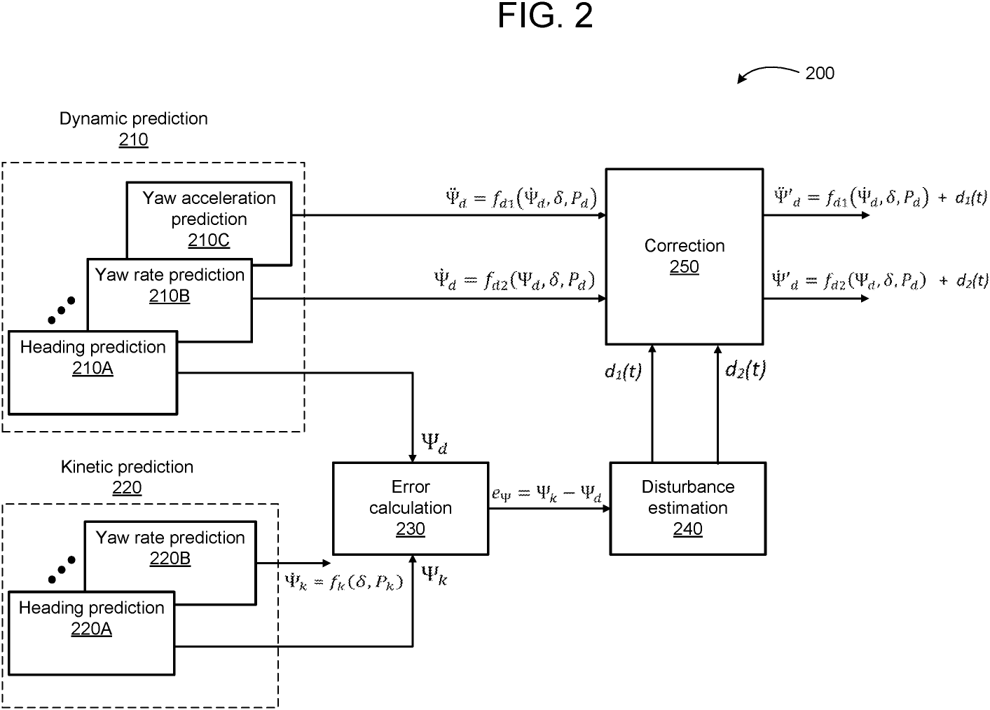

FIG. 2 is a functional block diagram illustrating an example system 200 for predicting a vehicle’s motion utilizing a disturbance estimation generated based on an error between primary and secondary models to correct prediction inaccuracies in the primary model in accordance with one embodiment of the systems and methods described herein. The system 200 includes a dynamic prediction section 210 that includes various prediction modules for making predictions regarding the vehicle’s motion based on a dynamic model, and a kinematic prediction section 220 that includes various modules for making predictions regarding the vehicle’s motion based on a kinematic model. In the example system 200, heading prediction module 210A, yaw rate prediction module 210B, and yaw acceleration prediction module 210C are shown in the dynamic prediction section 210, and heading prediction module 220A and yaw rate prediction module 220B are shown in the kinematic prediction section 220. Additional prediction modules for predicting other motion parameters such as lateral velocity may be included in the dynamic and kinematic prediction sections 210, 220. In the illustrated example, the dynamic model is used as the primary model, and the kinematic model is used as the secondary model.

In operation, the heading prediction module 210A, the yaw rate prediction module 210B, and the yaw acceleration prediction module 210C make, respectively, heading, yaw rate, and yaw acceleration predictions based on the dynamic model. At the same time, the heading prediction module 220A and the yaw rate prediction module 220B make, respectively, heading and yaw rate predictions based on the kinematic model in the background.

In the following discussions, Ψ, Ψ^{̇}, and Ψ^{̈} represent, respectively, heading, yaw rate, and yaw acceleration.

In the example dynamic prediction section 210, the heading prediction module 210A outputs dynamic heading Ψ_{d}, the yaw rate prediction module 210B outputs dynamic yaw rate Ψ̅̇_{d}, and the yaw rate acceleration module 210C outputs dynamic yaw rate acceleration Ψ̅̇_{d},

The dynamic yaw acceleration and the dynamic yaw rate can be expressed in a vector format as:

$$\left[\begin{matrix}{\ddot{\text{Ψ}}}_{d} \\ {\dot{\text{Ψ}}}_{d}\end{matrix}\right] = f \left(\left[\begin{matrix}{\dot{\text{Ψ}}}_{d} \\ {\text{Ψ}}_{d}\end{matrix}\right] , δ , {P}_{d}\right) \qquad \text{(1)}$$

where δ represents a control input and P_{d} represents parameters for dynamic model. Equation (1) can be alternatively written as:

$${\ddot{\text{Ψ}}}_{d} = {f}_{d 1} \left({\dot{\text{Ψ}}}_{d} , δ , {P}_{d}\right) \qquad \text{(2)}$$

$${\dot{\text{Ψ}}}_{d} = {f}_{d 2} \left({\text{Ψ}}_{d} , δ , {P}_{d}\right) \qquad \text{(3)}$$

In the example kinematic prediction section 220, the heading prediction module 220A outputs kinematic heading Ψₖ, and the yaw rate prediction module 220B outputs kinematic yaw rate Ψ̅ₖ given by:

$${\dot{\text{Ψ}}}_{k} = {f}_{k} \left(δ , {P}_{k}\right) \qquad \text{(4)}$$

To get from these differential equations to yaw rate and heading predictions for both dynamic and kinematic models, the equations are integrated, either analytically or numerically (e.g., by computer algorithm).

The system 200 further includes error calculation module 230 that receives dynamic and kinematic heading values Ψ_{d} and Ψₖ from, respectively, the heading prediction module 210A and the heading prediction module 220A and outputs heading error e_{Ψ}, given by e_{Ψ} = Ψₖ - Ψ_{d} in this embodiment.

The system 200 further includes disturbance estimation module 240 that receives the heading error e_{Ψₕ} from the error calculation module 230 and determines two disturbance estimates, namely, d₁(t) for Ψ̅_{d} and d₂(t) for Ψ̅_{d}. In one example, a disturbance observer g can be designed as a function of e_{Ψ}, where the observer g could be a Luenberger observer.

The system 200 further includes correction module 250 that receives dynamic yaw acceleration Ψ̅_{d} and dynamic yaw rate Ψ̅_{d} from the yaw acceleration prediction module 210C and the yaw rate prediction module 210B, respectively, and also receives disturbance estimates d₁(t) and d₂(t) from the disturbance estimation module 240 and outputs corrected dynamic yaw acceleration Ψ′_{d} and corrected yaw rate Ψ̅′̅_{d} given by:

$${{\ddot{\text{Ψ}}}^{′}}_{d} = {f}_{d 1} \left({\dot{\text{Ψ}}}_{d} , δ , {P}_{d}\right) + {d}_{1} \left(t\right) \qquad \text{(5)}$$

$${{\dot{\text{Ψ}}}^{′}}_{d} = {f}_{d 2} \left({\text{Ψ}}_{d} , δ , {P}_{d}\right) + {d}_{2} \left(t\right) \qquad \text{(6)}$$

Thus, the dynamic predictions for yaw acceleration, yaw rate, and heading can be improved in the augmented dynamic model.

An algorithm for calculating the disturbance estimation can be a discrete algorithm or a trained neural network. In the case of a discrete algorithm, measured observations between different types of error and how they impact other measurements can be determined to develop an appropriate discrete algorithm that can generate the disturbance estimation.

The mathematical expressions for generating disturbance estimation based on an error between primary and secondary models given above are for continuous dynamics, but it can be done similarly for discrete time dynamics, resulting in a discrete algorithm. In particular, the function g(e_{Ψ}) can be a discrete algorithm, a Luenberger observer, or a machine learning model such as a trained neural network. In some embodiments, dynamic parameters P_{d} and kinematic parameters Pₖ can be inputs to the function g(e_{Ψ}). A neural network may be well suited for a complex system that requires multiple parameters.

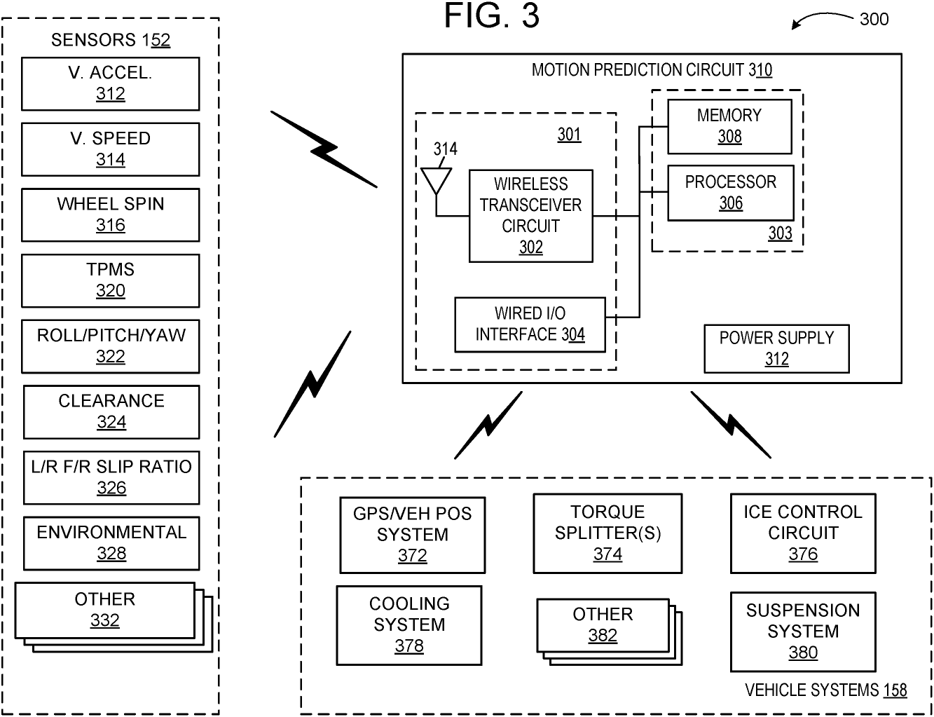

FIG. 3 illustrates an example architecture for predicting a vehicle’s motion utilizing a disturbance estimation generated based on an error between primary and secondary models to correct prediction inaccuracies in the primary model in accordance with one embodiment of the systems and methods described herein. Referring now to FIG. 3, in this example, vehicle motion prediction system 300 includes a motion detection circuit 310, a plurality of sensors 352, and a plurality of vehicle systems 158. Sensors 152 and vehicle systems 158 can communicate with motion prediction circuit 310 via a wired or wireless communication interface. Although sensors 152 and vehicle systems 158 are depicted as communicating with motion prediction circuit 310, they can also communicate with each other as well as with other vehicle systems. Motion prediction circuit 310 can be implemented as an ECU or as part of an ECU such as, for example electronic control unit 50. In other embodiments, motion prediction circuit 310 can be implemented independently of the ECU.

Motion prediction circuit 310 in this example includes a communication circuit 301, a decision circuit (including a processor 306 and memory 308 in this example) and a power supply 312. Components of motion prediction circuit 310 are illustrated as communicating with each other via a data bus, although other communication in interfaces can be included.

Processor 306 can include a GPU, CPU, microprocessor, or any other suitable processing system. The memory 308 may include one or more various forms of memory or data storage (e.g., flash, RAM, etc.) that may be used to store the dynamic model parameters including nominal tire cornering stiffness values, images (analysis or historic), point parameters, instructions and variables for processor 306 as well as any other suitable information. Memory 308, can be made up of one or more modules of one or more different types of memory, and may be configured to store data and other information as well as operational instructions that may be used by the processor 206 in the motion prediction circuit 310 to execute a dynamic model software.

Although the example of FIG. 3 is illustrated using processor and memory circuitry, as described below with reference to circuits disclosed herein, decision circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a motion prediction circuit 310.

Communication circuit 301 either or both a wireless transceiver circuit 302 with an associated antenna 314 and a wired I/O interface 304 with an associated hardwired data port (not illustrated). As this example illustrates, communications with motion prediction circuit 310 can include either or both wired and wireless communications circuits 301. Wireless transceiver circuit 302 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by motion prediction circuit 310 to/from other entities such as sensors 152 and vehicle systems 158.

Wired I/O interface 304 can include a transmitter and a receiver (not shown) for hardwired communications with other devices. For example, wired I/O interface 304 can provide a hardwired interface to other components, including sensors 152 and vehicle systems 158. Wired I/O interface 304 can communicate with other devices using Ethernet or any of a number of other wired communication protocols whether standardized, proprietary, open, point-to-point, networked or otherwise.

Power supply 312 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 152 such as those described above with reference to the example of FIG. 1. Sensors 152 can include additional sensors that may or not otherwise be included on a standard vehicle 10 with which the vehicle motion prediction system 300 is implemented. In the illustrated example, sensors 152 include vehicle acceleration sensors 312, vehicle speed sensors 314, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, and environmental sensors 328 (e.g., to detect salinity or other environmental conditions). Additional sensors 332 can also be included as may be appropriate for a given implementation of vehicle motion prediction system 300.

Vehicle systems 158 can include any of a number of different vehicle components or subsystems used to control or monitor various aspects of the vehicle and its performance. In this example, the vehicle systems 158 include a GPS or other vehicle positioning system 372; torque splitters 374 they can control distribution of power among the vehicle wheels such as, for example, by controlling front/rear and left/right torque split; engine control circuits 376 to control the operation of engine (e.g. Internal combustion engine 14); cooling systems 378 to provide cooling for the motors, power electronics, the engine, or other vehicle systems; suspension system 380 such as, for example, an adjustable-height air suspension system, and other vehicle systems.

During operation, motion prediction circuit 310 can receive information from various vehicle sensors, including the vehicle speed sensors 314, to determine the vehicle’s various states. Communication circuit 301 can be used to transmit and receive information between motion prediction circuit 310 and sensors 152, and motion prediction circuit 310 and vehicle systems 158. Also, sensors 152 may communicate with vehicle systems 158 directly or indirectly (e.g., via communication circuit 301 or otherwise).

In various embodiments, communication circuit 301 can be configured to receive data and other information from sensors 152 that is used in determining various states of the vehicle. Additionally, communication circuit 301 can be used to send an activation signal or other activation information to various vehicle systems 158 as part of the motion prediction. For example, as described in more detail below, communication circuit 301 can be used to send signals to, for example, one or more of: torque splitters 374 to control front/rear torque split and left/right torque split; motor controllers 376 to, for example, control motor torque, motor speed of the various motors in the system; ICE control circuit 376 to, for example, control power to engine 14 (e.g., to shut down the engine so all power goes to the rear motors, to ensure the engine is running to charge the batteries or allow more power to flow to the motors); cooling system (e.g., 378 to increase cooling system flow for one or more motors and their associated electronics); suspension system 380 (e.g., to increase ground clearance such as by increasing the ride height using the air suspension). The decision regarding what action to take via these various vehicle systems 158 can be made based on the information detected by sensors 152. Examples of this are described in more detail below.

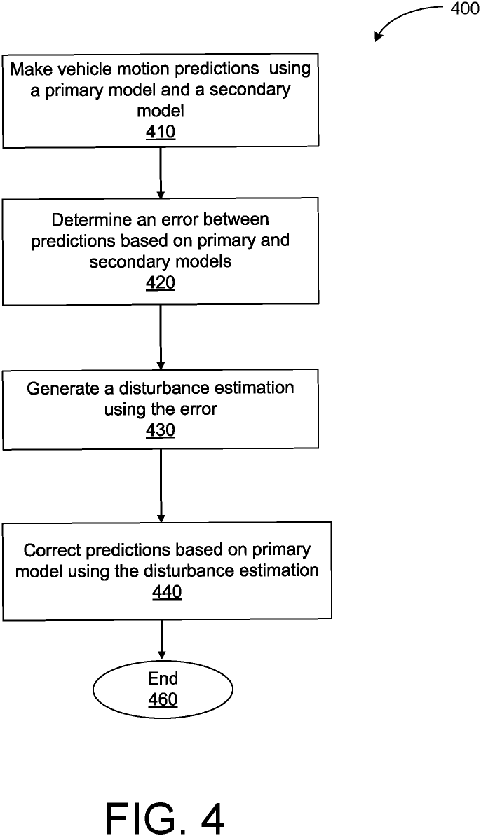

FIG. 4 illustrates an example process 400 for predicting a vehicle’s motion predicting a vehicle’s motion utilizing a disturbance estimation generated based on an error between primary and secondary models to correct prediction inaccuracies in the primary model in accordance with one embodiment of the systems and methods described herein. The process 400 can be implemented in a program executed on a processor, such as the processor 206 in the vehicle motion prediction system 200 shown in FIG. 3.

The process 400 starts at state 410, where various predictions regarding the vehicle’s motion are made using a primary model and a secondary model. In some embodiments, those predictions include, but are not limited, to heading, yaw rate (angular velocity about z direction), and lateral velocity. In some embodiments, the processor 306 in the vehicle motion prediction system 300 (FIG. 3) executes a first vehicle motion prediction program based on a primary model and also executes a second vehicle motion prediction program based on a secondary model simultaneously in the background. Such vehicle motion prediction programs can be stored in memory 308 of the vehicle motion prediction system 300. In some embodiments, the primary model is the dynamic model and the secondary model is the kinematic model. In other embodiments, the primary model is the kinematic model and the secondary model is the dynamic model.

The process 400 proceeds to state 420, where an error between a prediction made based on the primary model and a corresponding prediction made based on the secondary model is determined (e.g., calculated). For example, the error can be an error regarding heading based on the primary model and the secondary model. Measured observations can be used to compute the error at t = 0, and disturbance predictions for all time steps t of the model are dependent on that prediction.
Kinematic predictions Ψ_{κ}(t = 0), ..., Ψ_{κ}(t = N)
Dynamic predictions Ψ_{d}(t = 0), ..., Ψ_{d}(t = N)
Obtain errors: e_{Ψ}(t = 0), ..., e_{Ψ}(t = N)
Use disturbance observer to get: d(t = 0), ..., d(t = N)

The process 400 then proceeds to state 430, where a disturbance estimation is generated using the error determined or calculated at state 420. In some embodiments, the processor 306 generates the disturbance estimation using a discrete algorithm. In some embodiments, the discrete algorithm can be developed based on measured observations between different types of error and how they impact other measurements. For example, the measured observations can include taking data regarding relationships between errors regarding heading and errors in the yaw rate and/or the lateral velocity. In other embodiments, the disturbance estimation is generated based on a machine learning model, such as a neural network.

The process 400 proceeds to state 440, where one or more predictions made based on the primary mode are corrected using the disturbance estimate generated at state 430. For example, the disturbance estimation generated based on the calculated error regarding the heading based on the primary and secondary models can be used to correct inaccuracies in the yaw rate and lateral velocity predictions made based on the primary model.

The process 400 ends at state 450.

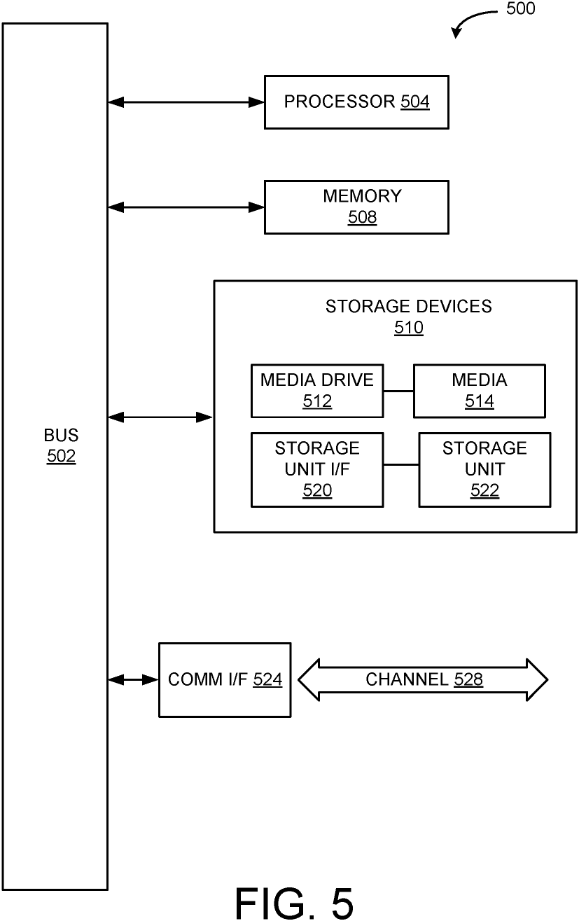

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA’s, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up user device 102, user system 104, and non-decrypting cloud service 106. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle motion prediction system comprising:
a memory configured to store a first program based on a primary model and a second program based on a secondary model; and
a processor configured to:
execute the first program based on the primary model to make a first set of predictions of the vehicle’s motion,
execute the second program based on the secondary model to make a second set of predictions of the vehicle’s motion,
determine an error between a prediction in the first set of predictions and the corresponding prediction in the second set of predictions,
generate a disturbance estimation using the error, and
correct one or more other predictions in the first set of predictions based on the primary model using the disturbance estimation.

2. The system of claim 1, wherein the first set of predictions includes predictions regarding heading, yaw rate, and yaw acceleration.

3. The system of claim 1, wherein the primary model is a dynamic model for predicting a vehicle motion and the secondary model is a kinematic model for predicting a vehicle motion.

4. The system of claim 1, wherein the primary model is a kinematic for predicting a vehicle motion and the secondary model is a dynamic model for predicting a vehicle motion.

5. The system of claim 1, wherein the error between one prediction in the first set of predictions and the corresponding one prediction in the second set of predictions is an error regarding heading based on the primary model and the secondary model.

6. The system of claim 5, wherein the error regarding the heading is used to generate the disturbance estimate.

7. The system of claim 6, wherein the disturbance estimate is used to correct predictions regarding yaw rate and lateral velocity.

8. The system of claim 1, wherein the disturbance estimation is generated using a discrete algorithm.

9. The system of claim 8, wherein the discrete algorithm is developed based on measured observations between different types of error and how they impact other measurements.

10. The system of claim 1, wherein the disturbance estimation is generated using a trained neural network.

11. A method for predicting a vehicle’s motion, the method comprising:
making a first set of predictions of the vehicle’s motion based on a primary model;
making a second set of predictions of the vehicle’s motion based on a secondary model;
determining an error between a prediction in the first set of predictions and the corresponding prediction in the second set of predictions;
generating a disturbance estimation using the error; and
correcting one or more other predictions in the first set of predictions based on the primary model using the disturbance estimation.

12. The method of claim 11, wherein the first set of predictions includes predictions regarding heading, yaw rate, and yaw acceleration.

13. The method of claim 11, wherein the primary model is a dynamic model for predicting a vehicle motion and the secondary model is a kinematic model for predicting a vehicle motion.

14. The method of claim 11, wherein the primary model is a kinematic for predicting a vehicle motion and the secondary model is a dynamic model for predicting a vehicle motion.

15. The method of claim 11, wherein the error between one prediction in the first set of predictions and the corresponding one prediction in the second set of predictions is an error regarding heading based on the primary model and the secondary model.

16. The method of claim 15, wherein the error regarding the heading is used to generate the disturbance estimate.

17. The method of claim 16, wherein the disturbance estimate is used to correct predictions regarding yaw rate and lateral velocity.

18. The method of claim 11, wherein the disturbance estimation is generated using a discrete algorithm.

19. The method of claim 18, wherein the discrete algorithm is developed based on measured observations between different types of error and how they impact other measurements.

20. The method of claim 11, wherein the disturbance estimation is generated using a trained neural network.
